(19) United States
(12) Patent Application Publication
(10) Pub. No.: US 2016/0139770 A1
(43) Pub. Date: May 19, 2016

(54) METHOD FOR PRESENTING PROMPT ON MOBILE TERMINAL AND THE SAME MOBILE TERMINAL

(71) Applicant: HTC Corporation, Taoyuan County (TW)

(72) Inventor: Jinhua ZHANG, Taoyuan County (TW)

(21) Appl. No.: 14/542,660

(22) Filed: Nov. 17, 2014

(51) Int. Cl. G06F 3/0481; G06F 3/0484

(52) U.S. Cl. CPC G06F 3/04817; G06F 3/04842

(57) ABSTRACT

The disclosure relates to a method for presenting prompt on mobile terminal and the same mobile terminal. The method includes: the processor determines whether an application of the mobile terminal has received a new message; the processor determines whether the screen is in an unlocked state; and the screen displays jittering of the icon of the application, based on a determination that the application has received the new message and the screen is in the unlocked state.

### TECHNICAL FIELD

The present disclosure generally relates to the field of mobile terminal, and more particularly to a method for presenting prompt on mobile terminal and the same mobile terminal.

### BACKGROUND

In the related art, a mobile terminal is typically provided with one or more applications which are capable of receiving corresponding messages. Upon receiving a message, the mobile terminal will prompt the user that an application has received a new message, for example, through a ringtone.

### SUMMARY

Embodiments of the present disclosure provide a method for presenting prompt on a mobile terminal including a screen and a processor, and the method including: the processor determines whether an application of the mobile terminal has received a new message; the processor determines whether the screen is in an unlocked state; and the screen displays that the icon of the application is jittering, based on a determination that the application has received the new message and the screen is in the unlocked state.

Embodiments of the present disclosure also provide a mobile terminal, including: a screen; a memory configured to store computer executable instructions; a processor configured to execute the computer executable instructions, to cause the mobile terminal to perform: determining, by the processor, whether an application of the mobile terminal has received a new message; determining, by the processor, whether the screen is in an unlocked state; and displaying jittering of the icon of the application on the screen, based on a determination that the application has received the new message and the screen is in the unlocked state.

Embodiments of the present disclosure also provide a non-volatile computer-readable storage medium, on which a program for prompting a message used for a mobile terminal is stored, the mobile terminal including a screen and a processor. The program is executed to cause the mobile terminal to perform: determining, by the processor, whether an application of the mobile terminal has received a new message; determining, by the processor, whether the screen is in an unlocked state; and displaying jittering of the icon of the application on the screen, based on a determination that the application has received the new message and the screen is in the unlocked state.

Embodiments of the present disclosure also provide a mobile terminal, including a processing module and a displaying module. The processing module is configured to determine whether an application of the mobile terminal has received a new message; and to determine whether the screen is in an unlocked state; and controls the displaying module to display jittering of the icon of the application on the screen, based on a determination that the application has received the new message and the screen is in the unlocked state.

Alternatively, the mobile terminal also includes: a pupil position acquiring module configured to acquire information about the position of the pupils of the user and transmits the acquired information to the processing module. The displaying module is configured to display jittering of the icon of the application on the screen, based on a determination that the application has received the new message, the screen is in the unlocked state and the pupils of the user point to the screen.

Alternatively, the processing module is configured to determine whether the icon has kept jittering for a threshold period; and to control the icon to stop jittering, based on a determination that the icon has kept jittering for the threshold period.

Alternatively, the processing module is configured to determine whether the received new message has been marked as a read message; and to control the icon to stop jittering, based on a determination that the received new message has been marked as the read message.

### BRIEF DESCRIPTION OF THE DRAWINGS

FIG. 1 is a flowchart showing a method 1000 for presenting prompt on mobile terminal according to an embodiment of the present disclosure.

FIG. 2 is a flowchart showing a method 2000 for presenting prompt on mobile terminal according to an embodiment of the present disclosure.

FIG. 3 is a flowchart showing a method 3000 for presenting prompt on mobile terminal according to an embodiment of the present disclosure.

FIG. 4 is a flowchart showing a method 4000 for presenting prompt on mobile terminal according to an embodiment of the present disclosure.

FIG. 5 is a flowchart showing a method 5000 for presenting prompt on mobile terminal according to an embodiment of the present disclosure.

FIG. 6 is a flowchart showing a method 6000 for presenting prompt on mobile terminal according to an embodiment of the present disclosure.

FIG. 7 is a schematic view showing a jittering icon of an application according to an embodiment of the present disclosure.

FIG. 8 is a block diagram showing a mobile terminal 10 according to an embodiment of the present disclosure.

FIG. 9 is a block diagram showing a mobile terminal 20 according to an embodiment of the present disclosure.

FIG. 10 is a block diagram showing a mobile terminal 600 according to an embodiment of the present disclosure.

### DETAILED DESCRIPTION

Hereinafter, embodiments of the present application will be described in detail. It should be noted that the embodiments described herein are merely for illustration, and not for limitation of the scope of the present application.

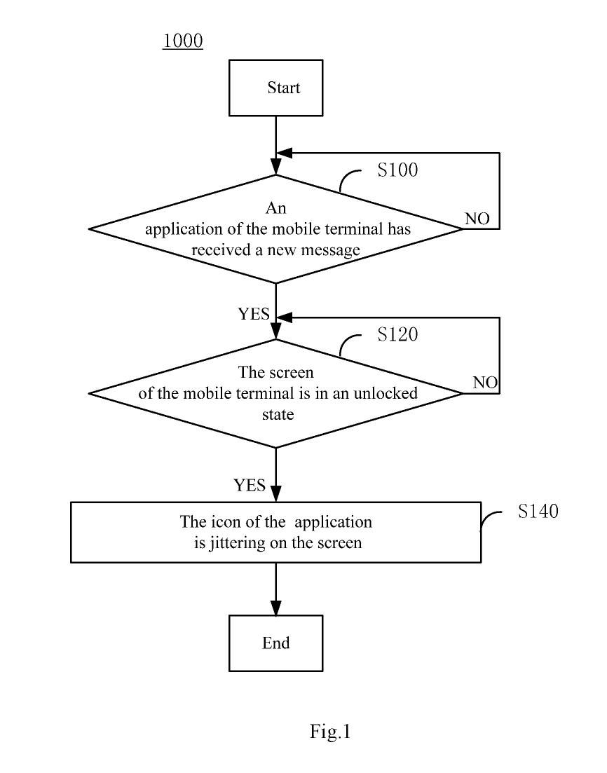

FIG. 1 is a flowchart showing a method 1000 for presenting prompt on mobile terminal according to an embodiment of the present disclosure. As shown in FIG. 1, at step S100, a processor of a mobile terminal determines whether an application of the mobile terminal has received a new message. For example, the processor of the mobile terminal determines whether an application such as a browser of the mobile terminal has received a new message, for example, an upgrade message.

If it is determined at step S100 that an application of the mobile terminal has received a new message, the processor determines whether a screen of the mobile terminal is in an unlocked state at step S120.

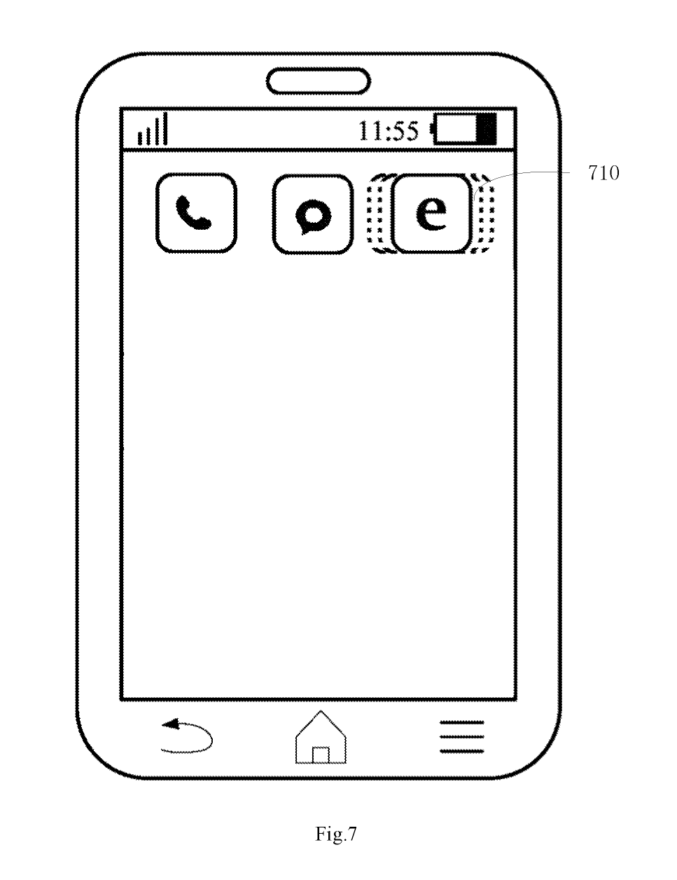

At step S140, based on the determination that an application has received a new message and the screen is in the unlocked state, the screen displays that an icon of the application is jittering on the screen. For example, if it is determined that the browser of the mobile terminal has received a new message at step S100, and it is determined that the screen of the mobile terminal is in the unlocked state at step S120, the screen displays that the icon 710 of the browser is jittering (such as jittering from left to right) on the screen at step S140, as shown FIG. 7.

For example, the processor determines whether the screen of the mobile terminal is in the unlocked stat when an application of the terminal has received a new message. If the screen is in a locked state, a prompt, for example in manner of a ringtone or vibration and the like, is issued, or the prompt is not issued. In case where an application has received a new message and the new message has not been read, the screen displays that an icon of the application receiving the new message is jittering as long as the processor detects that the screen is in the unlocked state, no matter whether or not a prompt has been issued when the screen of the mobile terminal is in the locked state.

According to the above embodiments, if it is detected that an application of the mobile terminal has received a new message and the screen of the mobile terminal is in the unlocked state (the screen is in the unlocked state typically means that the user is watching the screen of the mobile terminal), the displays that the icon of the application is jittering on the screen; if an application of the mobile terminal has received a new message and it is detected that the screen of the mobile terminal is in a locked state (the screen is in the locked state typically means that the user is not watching the mobile terminal), the icon of the application is displayed on the screen without jittering. By this way, it is ensured that the icon is jittering when the user watches the screen, and thus it is effectively ensured that the user may be prompted that an application has received a new message.

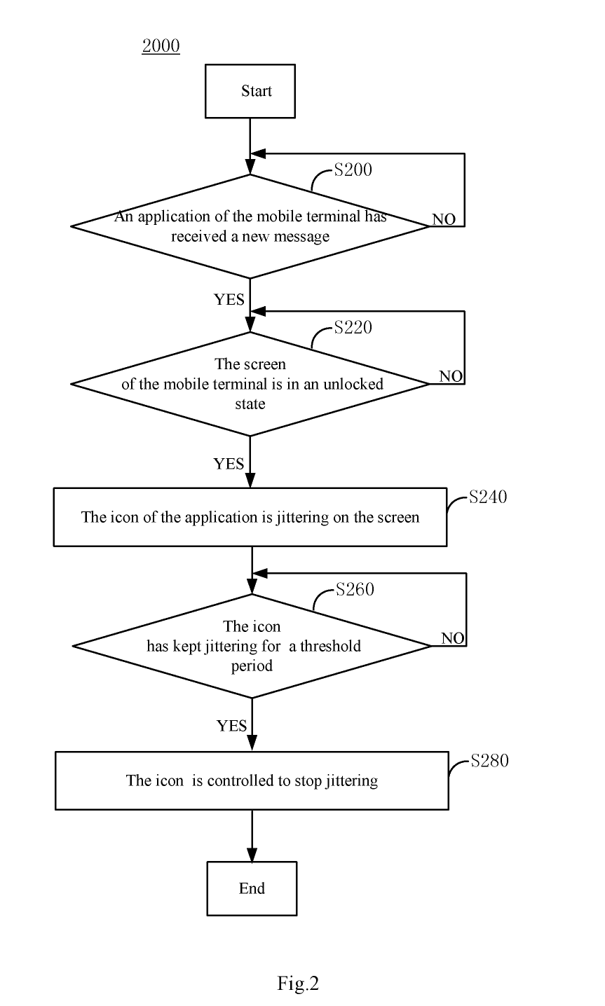

FIG. 2 is a flowchart showing a method 2000 for presenting prompt on mobile terminal according to an embodiment of the present disclosure, in which steps S200-S240 are the same with steps S100-S140 in FIG. 1, and the description thereof will not be repeated herein.

As shown in FIG. 2, at step S260, the processor determines whether the icon has kept jittering for a threshold period. At step S280, based on the determination that the icon has kept jittering for a threshold period, the icon of the application stops jittering.

For example, at step S200, it is determined that the browser has received a new message (for example, an upgrade prompt). At step S220 it is determined that the screen is in the unlocked state. At step 240, the icon 710 of the browser is jittering on the screen (as shown in FIG. 7). At step S260, the processor determines whether the icon 710 of the browser has kept jittering for a threshold period, for example 3 seconds. If it is determined at step S260 that the icon 710 of the browser has kept jittering for a threshold period, for example 3 seconds, the processor controls the icon 710 of the browser to stop jittering.

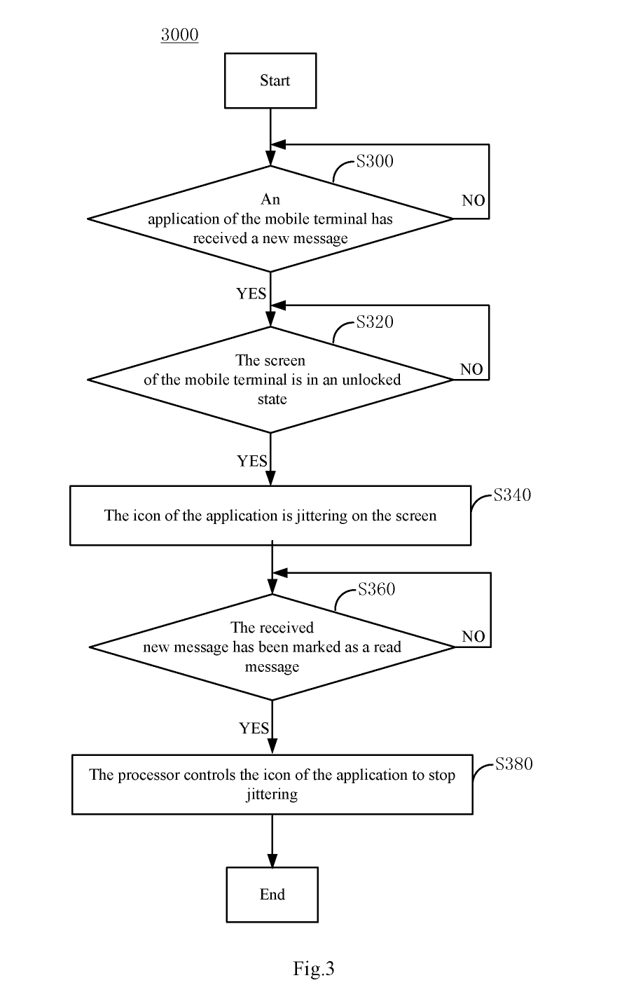

FIG. 3 is a flowchart showing a method 3000 for presenting prompt on mobile terminal according to an embodiment of the present disclosure, in which steps S300-S340 are the same with steps S100-S140 in FIG. 1, and the description thereof will not be repeated herein.

As shown in FIG. 3, at step S360, the processor determines whether the received new message has been marked as a read message. At step S380, based on the determination that the received new message has been marked as the read message, the application stops jittering.

For example, at step S300, it is determined that the browser has received a new message (for example, an upgrade prompt). At step S320, it is determined that the screen is in the unlocked state. At step S340, the icon 710 of the browser is jittering on the screen (as shown in FIG. 7). At step S360, it is determined whether the new message received by the browser has been marked as the read message. If it is determined at step S360 that the new message received by the browser has been marked as the read message, the processor controls the icon 710 of the browser to stop jittering at step S380.

According to the above embodiments, in case where the icon of the application is displayed jittering on the screen, the processor also determines whether the icon has kept jittering for a threshold period, and based on the determination that the icon has kept jittering for a threshold period, the icon of the application stops jittering. By this way, it is ensured that the icon is jittering when the user watches the screen, it is effectively ensured that the user may be prompted that the application has received a new message, and the jittering may be stopped under a predetermined condition to improve the user's experience.

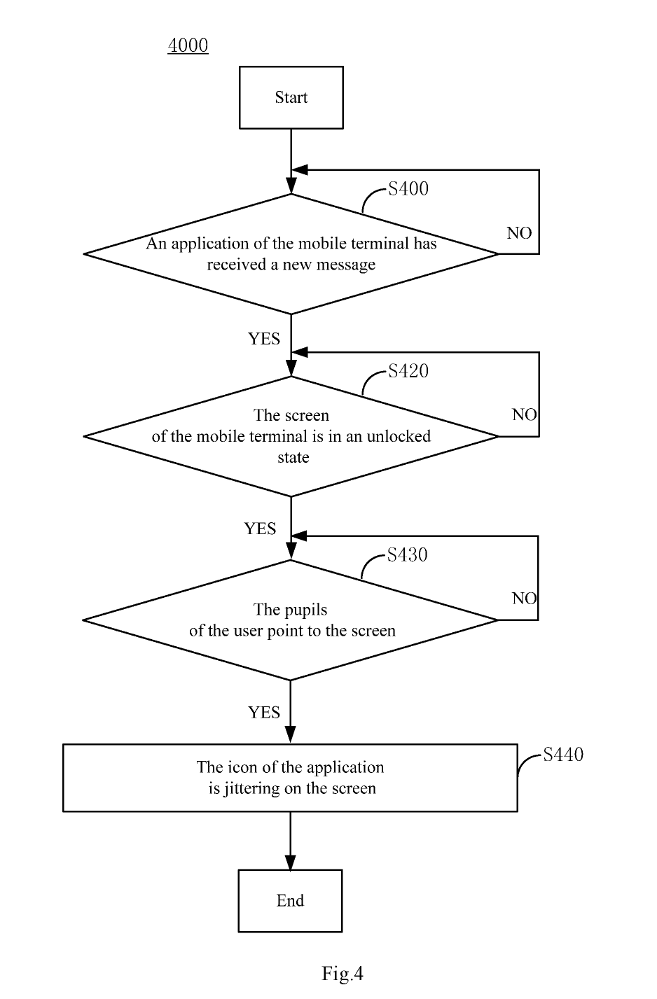

FIG. 4 is a flowchart a method 4000 for presenting prompt on mobile terminal according to an embodiment of the present disclosure. At step S400, the processor of the mobile terminal determines whether an application of the mobile terminal receives a new massage. For example, the processor of the mobile terminal determines whether the browser of the mobile terminal has received a new message, for example, an upgrade message.

If it is determined at step S400 that an application of the mobile terminal has received a new message, the processor determines whether the screen of the mobile terminal is in the unlocked state at step S420.

If it is determined at step S420 that the screen of the mobile terminal is in the unlocked state, at step S430 it is determined whether pupils of the user point to the screen. For example, the processor acquires information about the position of the pupils of the user through a camera of the mobile terminal, and determines whether the pupils of the user point to the screen of the mobile terminal based on the acquired information.

At step S440, based on the determination that a new message is received by an application and the screen is in the unlocked state and the pupils of the user point to the screen, the icon of the application is jittering on the screen.

For example, if it is determined that the browser of the mobile terminal has received a new message at step S400, it is determined that the screen of the mobile terminal is in the unlocked state at step S420, and it is determined that the pupils of the user point to the screen at step S430, the icon 710 of the browser is jittering, for example from left to right, on the screen at step S440, as shown in FIG. 7.

In some embodiments, orders of the steps to determine whether the screen of the screen of the mobile terminal is in the unlocked state and to determine whether the pupils of the user point to the screen may be exchanged, and they may also be performed simultaneously.

According to the above embodiments, if it is detected that an application of the mobile terminal has received a new message and the screen of the mobile terminal is in the unlocked state (the screen is in the unlocked state typically means that the user is watching the screen of the mobile terminal), and it is detected that the pupils of the user point to the screen (which typically means the user is watching the screen of the mobile terminal), the icon of the application is jittering on the screen. If an application of the mobile terminal has received a new message, the icon of the application is not jittering on the screen as long as it is detected that the screen of the mobile terminal is in the locked state (which typically means the user is not watching the mobile terminal) or it is detected that the pupils of the user do not point to the screen (which typically means the user is not watching the mobile terminal). By this way, it is ensured that the icon is jittering when the user watches the screen, and thus it is effectively ensured that the user may be prompted that the application has received a new message.

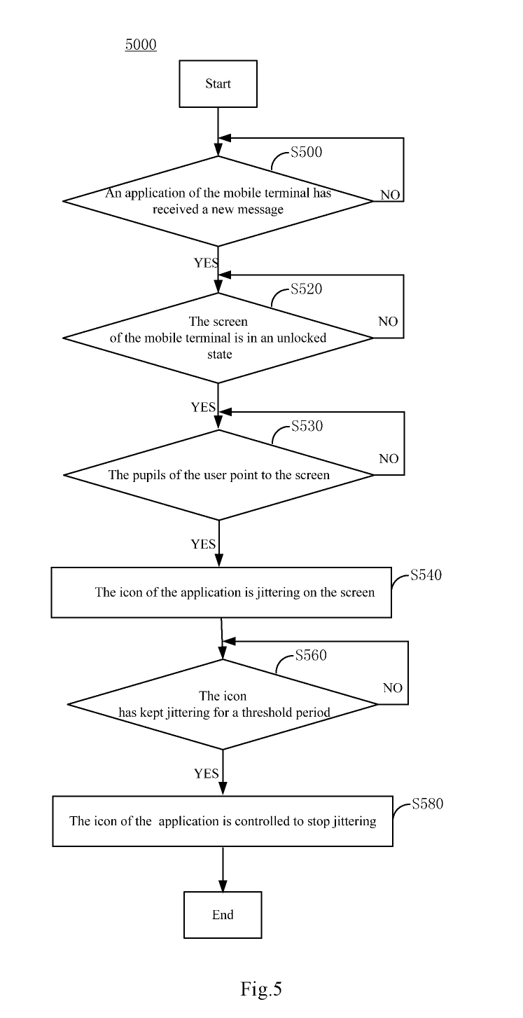

FIG. 5 is a flowchart showing a method 5000 for presenting prompt on mobile terminal according to an embodiment of the present disclosure, in which steps S500-S540 are the same with steps S400-S440 in FIG. 4, and thus the description thereof will not be repeated herein.

As shown in FIG. 5, at step S560, the processor determines whether the icon has kept jittering for a threshold period. At step S580, based on the determination that the icon has kept jittering for a threshold period, the icon of the application stops jittering.

For example, at step S500, it is determined that the browser has received a new message (for example, an upgrade prompt). At step S520, it is determined that the screen is in the unlocked state. At step S540, the icon 710 of the browser is jittering on the screen (as shown in FIG. 7). At step S560, the processor determines whether the icon 710 of the browser has kept jittering for a threshold period, for example 3 seconds. If at step S560 it is determined that the icon 710 of the browser has kept jittering for the threshold period, for example 3 seconds, the processor controls the icon 710 of the browser to stop jittering.

According to the above embodiments, in case where the icon of the application is jittering on the screen, it is also determined whether the icon has kept jittering for the threshold period, and the icon of the application stops jittering based on the determination that the icon has kept jittering for the threshold period. By this way, it is ensured that the icon is jittering when the user watches the screen, and it is effectively ensured that the user may be prompted that the application has received a new message, and the jittering may be stopped under a predetermined condition to improve the user's experience.

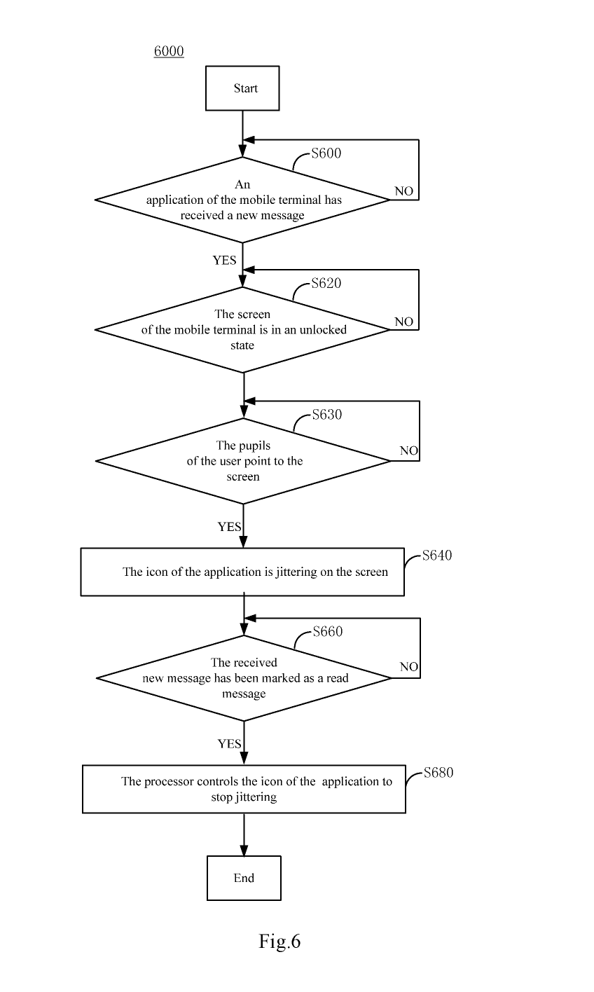

FIG. 6 is a flowchart showing a method 6000 for presenting prompt on mobile terminal according to an embodiment of the present disclosure, in which steps S600-S640 are the same with steps S400-S440 in FIG. 4, and thus the description thereof will not be repeated herein.

As shown in FIG. 6, at step S660, the processor determines whether the received new message has been marked as a read message. At step S680, based on the determination that the received new message has been marked as the read message, the application stops jittering.

For example, at step S600, it is determined that the browser has received a new message (for example, an upgrade prompt). At step S620, it is determined that the screen is in the unlocked state. At step S630, it is determined that the pupils of the user point to the screen. At step S640, the icon 710 of the browser is jittering on the screen (as shown in FIG. 7). At step S660, it is determined whether the new message received by the browser has been marked as the read message. If it is determined that the new message received by the browser has been marked as the read message at step S660, the processor controls the icon 710 of the browser to stop jittering at step S680.

According to the above embodiments, in case where the icon of the application is displayed jittering on the screen, it is also determined whether the icon has kept jittering for the threshold period, and the icon of the application stops jittering based on the determination that the icon has kept jittering for the threshold period. By this way, it is ensured that the icon is jittering when the user watches the screen, it is effectively ensured that the user may be prompted that the application has received a new message, and the jittering may be stopped under a predetermined condition to improve the user's experience.

The present disclosure also involves a mobile terminal including: a memory configured to store computer-executable instructions, and a processer configured to execute computer-executable instructions to cause the mobile terminal to perform the above methods. For example, it is determined by the processor whether an application of the mobile terminal has received a new message; it is determined by the processor whether the screen is in the unlocked state; and based on the determination that an application has received a new message and the screen is in the unlocked state, the icon of the application is jittering on the screen.

Alternatively, the processor is also configured to execute computer-executable instructions to cause the mobile terminal to perform: determining, by the processor, whether an application of the mobile terminal has received a new message; determining, by the processor, whether the screen is in the unlocked state; determining, by the processor, whether the pupils of the user point to the screen; and displaying jittering of the icon of the application on the screen based on the determination that an application has received a new message, the screen is in the unlocked state and the pupils of the user point to the screen.

Alternatively, the processor is also configured to execute computer-executable instructions to cause the mobile terminal to perform: determining, by the processor, whether the icon has kept jittering for a threshold period; and stopping jittering based on the determination that the icon has kept jittering for the threshold period.

Alternatively, the processor is also configured to execute computer-executable instructions to cause the mobile terminal to perform: determining, by the processor, whether the received new message has been marked as a read message; and stopping jittering based on the determination that the received new message has been marked as the read message.

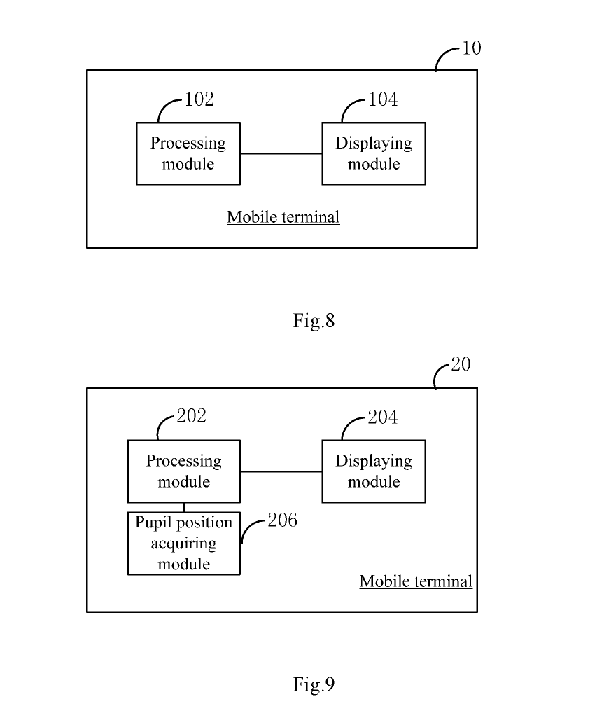

FIG. 8 is a block diagram showing a mobile terminal 10 according to an embodiment of the present disclosure. As shown in FIG. 8, the mobile terminal 10 includes a processing module 102 and a displaying module 104. The processing module 102 is configured to determine whether an application of the mobile terminal 10 has received a new message; to determine whether the screen (not shown) is in the unlocked state; and to make the displaying module 104 display jittering of the icon of the application based on the determination that an application has received a new message and the screen is in the unlocked state.

For example, the processing module 102 of the mobile terminal 10 determines whether an application of the mobile terminal 10 has received a new message. For example, the processing module 102 of the mobile terminal 10 determines whether the browser of the mobile terminal has received a new message, for example, an upgrade message.

The processing module 102 also determines whether the screen of the mobile terminal 10 is in the unlocked state. For example, if it is determined that the browser of the mobile terminal 10 has received a new message, the processing module 102 determines whether the screen of the mobile terminal 10 is in the unlocked state.

Based on the determination that an application has received a new message and the screen is in the unlocked state, the processing module 102 also controls the displaying module 104 to display jittering of the icon of the application on the screen. For example, if it determines that the browser of the processing module 102 has received a new message and the screen of the mobile terminal 10 is in the unlocked state, the processing module 102 controls the displaying module 104 to display jittering (for example from left to right) of the icon 710 of the browser on the screen , as shown in FIG. 7.

For example, the processing module 102 determines whether the screen of the mobile terminal 10 is in the unlocked state when the processing module 102 determines that an application of the mobile terminal 10 has received a new message. If the screen is in the locked state, a prompt, for example in manner of a ringtone or vibration and the like, is issued, or the prompt is not issued. In case where an application has received a new message and the new message has not been read, the displaying module 104 makes an icon of the application receiving the new message is jittering on the screen as long as the processing module 102 detects that the screen of the mobile terminal 10 is in the unlocked state, no matter whether or not a prompt has been issued when the screen of the mobile terminal 10 is in the locked state.

According to the above embodiments, if it is detected that an application of the mobile terminal has received a new message and the screen of the mobile terminal is in the unlocked state (the screen is in the unlocked state typically means that the user is watching the mobile terminal), the icon of the application is jittering on the screen. If an application of the mobile terminal has received a new message and it is detected that the screen of the mobile terminal is in the locked state (the screen is in the locked state typically means that the user is not watching the mobile terminal), the icon of the application is not jittering on the screen. By this way, it is ensured that the icon is jittering when the user watches the screen, and it is effectively ensured that the user may be prompted that an application has received a new message.

FIG. 9 is a block diagram showing a mobile terminal 20 according to an embodiment of the present disclosure. As shown in FIG. 9, the mobile terminal 20 includes a processing module 202, a displaying module 204 and a pupil position acquiring module 206.

The pupil position acquiring module 206 acquires information about the position of the pupils of the user and transmits the acquired information to the processing module 202. The processing module 202 is configured to determine whether an application of the mobile terminal 20 has received a new message; to determine whether the screen (not shown) is in the unlocked state; to determine whether the pupils of the user point to the screen based on the acquired information; and to control the displaying module 204 to display jittering of the icon of the application based on the determination that an application has received a new message, the screen is in the unlocked state, and the pupils of the user point to the screen.

For example, the processing module 202 of the mobile terminal 20 determines whether an application of the mobile terminal 20 has received a new message. For example, the processing module 202 of the mobile terminal 20 determines whether the browser of the mobile terminal has received a new message, for example, an upgrade message.

The processing module 202 also determines whether the screen of the mobile terminal 20 is in the unlocked state. For example, if it is determined that the browser of the mobile terminal 20 has received a new message, the processing module 202 determines whether the screen of the mobile terminal 20 is in the unlocked state.

The pupil position acquiring module 206 (such as a camera) acquires information about the position of the pupils of the user and transmits the acquired information to the processing module 202. The processing module 202 also determines whether the pupils of the user point to the screen based on the acquired information.

The processing module 202 controls the displaying module 204 to display jittering of the icon of corresponding application on the screen, based on the determination that an application has received a new message, the screen is in the unlocked state and pupils of the user point to the screen.

In some embodiments, orders of the determination of whether the screen of the screen of the mobile terminal is in the unlocked state and the determination of whether the pupils of the user point to the screen performed by the processing module 202 may be exchanged, or they may be performed simultaneously.

According to the above embodiments, if it is detected that an application of the mobile terminal has received a new message and the screen of the mobile terminal is in the unlocked state (the screen is in the unlocked state typically means that the user is watching the mobile terminal), and it is detected that the pupils of the user point to the screen (which typically means that the user is watching the mobile terminal), the icon of the application is jittering on the screen. If an application of the mobile terminal has received a new message, the icon of the application is not jittering on the screen as long as it is detected that the screen of the mobile terminal is in the locked state (the screen is in the locked state typically means that the user is not watching the mobile terminal) or it is detected that the pupils of the user do not point to the screen (which typically means that the user is not watching the mobile terminal). By this way, it is ensured that the icon is jittering when the user watches the screen, and it is effectively ensured that the user may be prompted that the application has received a new message.

Alternatively, the processing module 202 also determines whether the icon has kept jittering for a threshold period, and controls the icon of the application to stop jittering based on the determination that the icon has kept jittering for the threshold period.

For example, when the processing module 202 controls the displaying module 204 to display jittering of the icon of the browser on the screen, the processing module 202 determines that whether the icon of the browser has kept jittering for a threshold period, for example 3 seconds. If it is determined that the icon 710 of the browser has kept jittering for the threshold period, for example 3 seconds, the icon 710 of the browser is controlled to stop jittering.

Alternatively, the processing module 202 also determines whether the received new message has been marked as a read message, and controls the icon of the application to stop jittering based on the determination that the received new message has been marked as the read message.

For example, when the processing module 202 controls the displaying module 204 to display the jittering of the icon of the browser on the screen, the processing module 202 also determines whether the new message received by the browser has been marked as the read message. If it is determined that the new message received by the browser has been marked as the read message, the icon of the browser is controlled to stop jittering.

According to the above embodiments, in case where the icon of the application is jittering on the screen, it is also determines whether the icon has kept jittering for a threshold, and the icon of the application is controlled to stop jittering based on the determination that the icon has kept jittering for the threshold period. By this way, it is ensured that the icon is jittering when the user watches the screen, it is effectively ensured that the user may be prompted that the application has received a new message, and thus the jittering may be stopped under a predetermined condition to improve the user's experience.

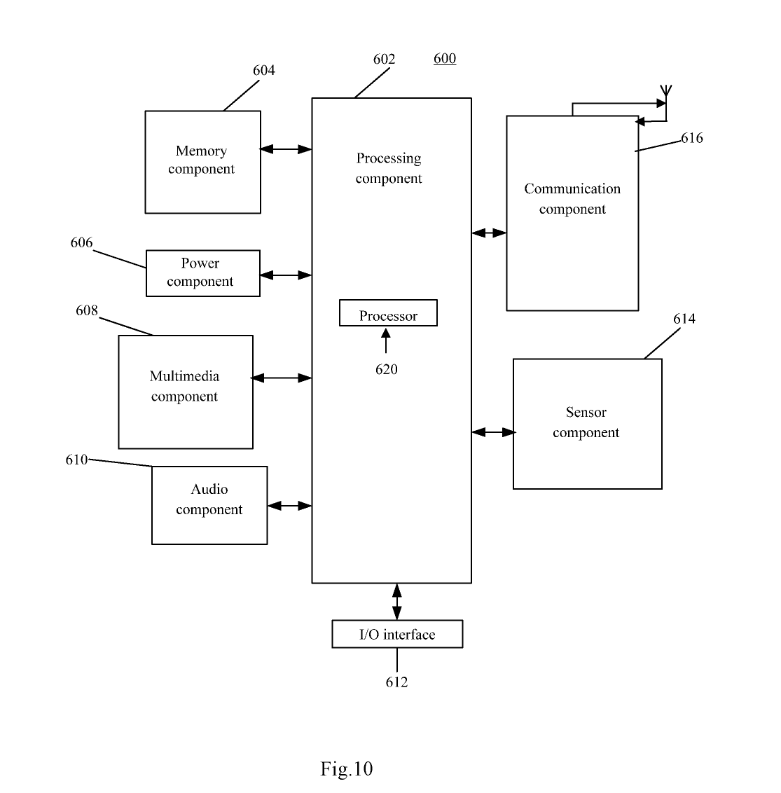

FIG. 10 is a block diagram showing a terminal device 600 according to an embodiment of the present disclosure. For example, the device 600 may be a mobile phone, a computer, a digital broadcast terminal, a messaging transceiver, a gaming console, a tablet, a medical device, exercise equipment, a personal digital assistant, and the like.

As shown in FIG. 10, the device 600 may include one or more of the following components: a processing component 602, a memory component 604, a power component 606, a multimedia component 608, an audio component 610, an input/output (I/O) interface 612, a sensor component 614, and a communication component 616.

The processing component 602 typically controls overall operations of the control device 600, such as the operations associated with display, telephone calls, data communications, camera operations, and recording operations. The processing component 602 may include one or more processors 618 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 2G or 3G or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the device 600, for performing the above-described methods. For example, the non-transitory computer-readable storage medium may be a ROM, a RAM, a CD-ROM, a magnetic tape, a floppy disc, an optical data storage device, and the like.

For example, the program stored on the non-volatile computer-readable storage medium is executed to cause the mobile terminal to perform: determining, by the processor, whether an application of the mobile terminal has received a new message; determining, by the processor, whether the screen is in the unlocked state; and displaying jittering of the icon of the application on the screen based on the determination that an application has received a new message and the screen is in the unlocked state.

Alternatively, the program is also executed to cause the mobile terminal to perform: determining, by the processor, whether an application of the mobile terminal has received a new message; determining, by the processor, whether the screen is in the unlocked state; determining, by the processor, whether the pupils of the user point to the screen; and displaying jittering of the icon of the application on the screen based on the determination that an application has received a new message, the screen is in the unlocked state and the pupils of the user point to the screen.

Alternatively, the program is also executed to cause the mobile terminal to perform: determining, by the processor, whether the icon has kept jittering for a threshold period; and stopping jittering based on the determination that the icon has kept jittering for the threshold period.

Alternatively, the program is also executed to cause the mobile terminal to perform: determining, by the processor, whether the received new message has been marked as a read message; and stop jittering based on the determination that the received new message has been marked as the read message.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

Although the present application has been described in detail through the above exemplary embodiments, the scope of the present disclosure is not limited to the above embodiment, and those skilled in the art may make various modifications and alterations to the present application without departing from the scope and concept of the present application.

What is claimed is:

1. A method for presenting prompt on mobile terminal, the mobile terminal comprising a screen and a processor, the method comprising:
determining, by the processor, whether an application of the mobile terminal has received a new message;
determining, by the processor, whether the screen is in an unlocked state; and
displaying jittering of an icon of the application on the screen, based on a determination that the application has received the new message and the screen is in the unlocked state.

2. The method according to claim 1 further comprising:
determining, by the processor, whether the icon has kept jittering for a threshold period; and
controlling the icon to stop jittering, based on a determination that the icon has kept jittering for the threshold period.

3. The method according to claim 1 further comprising:
determining, by the processor, whether the received new message has been marked as a read message; and
controlling the icon to stop jittering, based on a determination that the received new message has been marked as the read message.

4. The method according to claim 1 further comprising:
determining, by the processor, whether pupils of a user point to the screen; and
displaying the jittering of the icon on the screen, based on a determination that the application has received the new message, the screen is in the unlocked state and the pupils of the user point to the screen.

5. The method according to claim 4 further comprising:
determining, by the processor, whether the icon has kept jittering for a threshold period; and
controlling the icon to stop jittering, based on a determination that the icon has kept jittering for the threshold period.

6. The method according to claim 4 further comprising:
determining, by the processor, whether the received new message has been marked as a read message; and
controlling the icon to stop jittering, based on a determination that the received new message has been marked as the read message.

7. A mobile terminal, comprising:
a screen;
a memory configured to store computer executable instructions;
a processor configured to execute the computer executable instructions, so as to cause the mobile terminal to perform:
determining, by the processor, whether application of the mobile terminal has received a new message;
determining, by the processor, whether the screen is in an unlocked state; and
displaying jittering of an icon of the application on the screen, based on a determination that the application has received the new message and the screen is in the unlocked state.

8. The mobile terminal according to claim 7, wherein the processer is further configured to execute the computer executable instructions to cause the mobile terminal to perform:
determining, by the processor, whether the icon has kept jittering for a threshold period; and
controlling the icon to stop jittering, based on a determination that the icon has kept jittering for the threshold period.

9. The mobile terminal according to claim 7, wherein the processer is further configured to execute the computer executable instructions to cause the mobile terminal to perform:
determining, by the processor, whether the received new message has been marked as a read message; and
controlling the icon to stop jittering, based on a determination that the received new message has been marked as the read message.

10. The mobile terminal according to claim 7, wherein the processer is further configured to execute the computer executable instructions to cause the mobile terminal to perform:
determining, by the processor, whether pupils of a user point to the screen; and
displaying the jittering of the icon on the screen, based on a determination that an application has received the new message, the screen is in the unlocked state and the position of the pupils of the user point to the screen.

11. The mobile terminal according to claim 10, wherein the processer is further configured to execute the computer executable instructions to cause the mobile terminal to perform:
determining, by the processor, whether the icon has kept jittering for a threshold period; and
controlling the icon to stop jittering, based on a determination that the icon has kept jittering for the threshold period.

12. The mobile terminal according to claim 10, wherein the processer is further configured to execute the computer executable instructions to cause the mobile terminal to perform:
determining, by the processor, whether the received new message has been marked as a read message; and
controlling the icon to stop jittering, based on a determination that the received new message has been marked as the read message.

13. A non-volatile computer-readable storage medium, on which a program for prompting a message used for a mobile terminal is stored, the mobile terminal comprising a screen and a processor, the program is executed to cause the mobile terminal to perform:
determining, by the processor, whether an application of the mobile terminal has received a new message;
determining, by the processor, whether the screen is in an unlocked state; and
displaying jittering of an icon of the application on the screen, based on a determination that the application has received the new message and the screen is in the unlocked state.

14. The non-volatile computer-readable storage medium according to claim 13, wherein the program is executed to cause the mobile terminal to perform:
determining, by the processor, whether the icon has kept jittering for a threshold period; and
controlling the icon to stop jittering, based on a determination that the icon has kept jittering for the threshold period.

15. The non-volatile computer-readable storage medium according to claim 13, wherein the program is executed to cause the mobile terminal to perform:
determining, by the processor, whether the received new message has been marked as a read message; and
controlling the icon to stop jittering, based on a determination that the received new message has been marked as the read message.

16. The non-volatile computer-readable storage medium according to claim 13, wherein the program is executed to cause the mobile terminal to perform:
determining, by the processor, whether pupils of a user point to the screen; and
displaying the jittering of the icon on the screen, based on a determination that the application has received the new message, the screen is in the unlocked state and the pupils of the user point to the screen.

17. The non-volatile computer-readable storage medium according to claim 16, wherein the program is executed to cause the mobile terminal to perform:
determining, by the processor, whether the icon has kept jittering for a threshold period; and
controlling the icon to stop jittering, based on a determination that the icon has kept jittering for the threshold period.

18. The non-volatile computer-readable storage medium according to claim 16, wherein the program is executed to cause the mobile terminal to perform:
determining, by the processor, whether the received new message has been marked as a read message; and
controlling the icon to stop jittering, based on a determination that the received new message has been marked as the read message.
